(19) United States
(12) Patent Application Publication
(10) Pub. No.: US 2004/0073828 A1
(43) Pub. Date: Apr. 15, 2004

(54) Transparent variable state mirroring

(76) Inventor: Vladimir Bronstein, Sunnyvale, CA (US)

Correspondence Address: BINGHAM, MCCUTCHEN LLP, THREE EMBARCADERO, SUITE 1800, SAN FRANCISCO, CA, 94111-4067, US

(21) Appl. No.: 10/233,259

(22) Filed: Aug. 30, 2002

(51) Int. Cl. G06F 11/00

(52) U.S. Cl. 714/6

(57) ABSTRACT

The system, method, and article of manufacture of the present invention provide a transparent variable state mirroring system. The transparent variable state mirroring system allows for hot standby redundancy support between entities. This is accomplished by providing a protocol and a supporting software architecture for an object-oriented messaging scheme used to maintain data synchronization between an active entity and a standby entity. As a result, the system, method, and article of manufacture of the present invention allow an application program executed by an active entity to manipulate (e.g., create, delete or update) application objects that contain state information (e.g., variables). When an application object is manipulated (e.g., created, deleted or updated) on the active entity, information is automatically transmitted via the messaging scheme from the active entity to a standby entity to update a corresponding application object on the standby entity.

### BACKGROUND OF THE INVENTION

1. Field of the Invention

The present invention relates generally to computing systems and, more particularly, to transparent variable state mirroring.

2. Related Art

In traditional computer systems, entities (e.g., a computer or other device capable of processing data) are often connected to each other and reliant on each other for information needed to continue processing. If one computer fails to operate, it affects the one or more connected computers. For example, a bank teller may submit a request for withdrawal of money for a customer from the customer's account at a client computer, and the information may be processed at a server computer. If the server computer fails, then the withdrawal transaction may not complete properly. If hundreds of bank tellers access that server computer from different client computers, then all of the bank tellers may have to shut down when the server computer fails.

Thus, computer systems typically incorporate a redundancy scheme in which a first entity is connected to a second entity. Both entities maintain the same information so that if one entity fails, then the other entity may take over processing of data. The entity that takes over is referred to as a “standby entity,” and the entity from which the standby entity takes over is referred to as an “active entity.”

“Hot standby” is a redundancy configuration in which the standby entity does not perform any functions relevant to the processing of information by the active entity, yet the standby entity is ready to take over the required functionality of the active entity immediately when a failure of the active entity is detected.

In order to make it possible for the standby entity to take over from the active entity, a “mirroring” process is used. In other words, information is transferred from the active entity to the standby entity to allow for data synchronization (e.g., synchronization of states) between the active entity and the standby entity in redundant systems. When the active and standby entities are synchronized, the state of the standby entity after some update interval should be identical to that of the active entity. If the state changes on the active entity, the standby entity is updated to the same state as soon as possible. “State” refers to both states of software variables that control performance of the system and hardware registers that also control system behavior.

An “explicit” mirroring process is used because the active and standby entities may be in different environmental conditions, in which case it cannot be guaranteed that exactly the same external signals are coming to both the active and standby entities. For example, a controlling console may be connected only to the active entity or a communication channel from a third entity may be connected only to the active entity.

The terms “transparent mirroring” and “application transparency” refer to mirroring processes that do not require inserting special code in application programs that change variables to perform mirroring.

Traditional systems usually require formatting special messages and transferring these messages over a communication channel from the active entity to the standby entity. The messages contain the identification of variables being changed and new values for the variables. The standby entity then decodes the messages and updates the states of software variables and hardware registers according to the information contained in the messages. Formatting messages, transferring messages, receiving messages, and decoding messages usually requires writing of special code in each place where the value of a variable has changed. Therefore, traditional message handling is time consuming and error prone.

There are two different tasks that are required in mirroring. The first is an initial bulk update of all variables at the standby entity. This is required when the standby entity is rebooted or otherwise starts processing. In this case, all variables on the active entity need to be created (in case of dynamic memory allocation) at the standby entity and updated with the active entity's state. This task is typically implemented by notifying components (e.g., functions) in an application program that contain those variables to transfer them over to the standby entity. The second task required in mirroring is run-time update, which is required once a variable changes its value due to external signals at the active entity. In traditional systems, run-time update also requires each component to transfer changed variables to the standby entity. Again, this requires inserting special code in the application program.

### SUMMARY OF THE INVENTION

A system, method, and article of manufacture, according to various embodiments of the present invention, provide transparent variable state mirroring. The transparent variable state mirroring allows for hot standby redundancy support between entities. This is accomplished by providing a protocol and a supporting software architecture for an object-oriented messaging scheme used to maintain data synchronization between an active entity and a standby entity. As a result, the system, method, and article of manufacture of embodiments of the present invention allow an application program executed by an active entity to manipulate (e.g., create, delete or update) application objects that contain state information (e.g., variables) on the active entity. When an application object is manipulated (e.g., created, deleted or updated), information is automatically transmitted via the messaging scheme from the active entity to a standby entity to update a corresponding application object on the standby entity. There is no longer a need to insert special code in application programs that change variable values, thereby overcoming limitations of the prior art.

### BRIEF DESCRIPTION OF THE DRAWINGS

The present disclosure may be better understood and its numerous features and advantages made apparent to those skilled in the art by referencing the accompanying drawings.

FIGS. 1A and 1B illustrate computing systems, in accordance with some embodiments of the invention.

FIG. 2A illustrates a software structure, while FIG. 2B illustrates a logical depiction of hardware structure, in accordance with some embodiments of the invention.

FIG. 3 illustrates a class hierarchy provided by the transparent variable state mirroring system, in accordance with some embodiments of the invention.

FIGS. 4A, 4B, and 4C are flow diagrams of operations of use of a class structure of FIG. 3, in accordance with some embodiments of the invention.

FIG. 5 is a flow diagram of an operation for bulk update, in accordance with some embodiments of the invention.

FIG. 6 is a flow diagram of an operation for application Factory registration, in accordance with some embodiments of the invention.

FIG. 7 is a flow diagram of an operation for application object creation on the active entity, in accordance with some embodiments of the invention.

FIG. 8 is a flow diagram of an operation for attribute registration, in accordance with some embodiments of the invention.

FIG. 9 is a flow diagram of an operation for application object creation on the standby entity, in accordance with some embodiments of the invention.

FIG. 10 is a flow diagram of an operation for update on the active entity, in accordance with some embodiments of the invention.

FIG. 11 is a flow diagram of an operation for update on the standby entity, in accordance with some embodiments of the invention.

The use of the same reference symbols in different drawings indicates similar or identical items.

### DETAILED DESCRIPTION OF THE PREFERRED EMBODIMENTS

Embodiments of the present invention provide a protocol and a supporting software architecture for a transparent variable state mirroring system used for hot standby redundancy support. Embodiments of the transparent variable state mirroring system provide an object-oriented messaging scheme used to maintain data synchronization between an active entity and a standby entity. In particular, an application program at an active entity manipulates (e.g., creates, deletes or updates) application objects that contain state information (e.g., variables). When an application object is manipulated (e.g., created, deleted or updated), information is automatically transmitted via the messaging scheme from the active entity to a standby entity to update the application object on the standby entity. This avoids the need to write code in the application program to update the standby entity for each possible state change of the active entity.

The transparent variable state mirroring system is applicable to an initial update of a standby entity as well as to run-time update of the standby entity. Additionally, the transparent variable state mirroring system is applicable to two types of updates of variables of an application object—creation/deletion of variables and changing an existing variable's value.

The transparent variable state mirroring system may transfer a group of messages or one message at a time across a communication channel between the active and standby entities. The messages contain variable states and creation/deletion entries (i.e. commands). The messages may be sent, for example, whenever objects are created/deleted or variables change value. The messages may be sent when a group of changes have been collected on the active entity. The messages are received on the standby entity, and the changes are replicated there.

The transparent variable state mirroring system may be applied to one to one redundancy schemes (e.g., in which case one active entity is connected to one standby entity) or one to N redundancy schemes (i.e. where N=two or more and represents the number of standby entities).

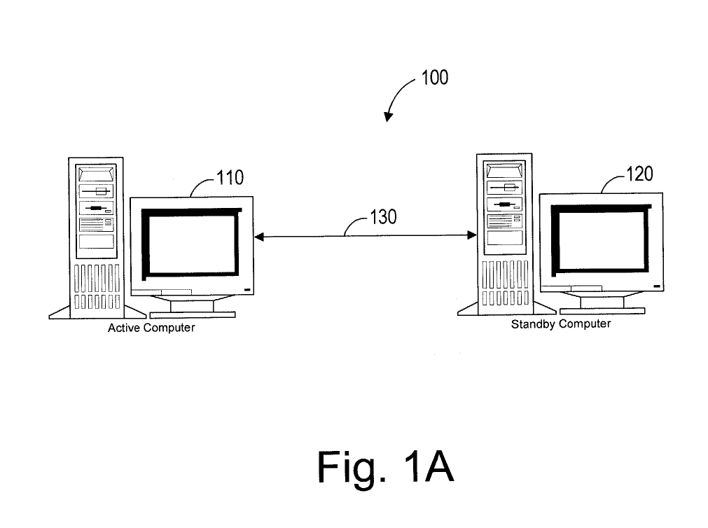

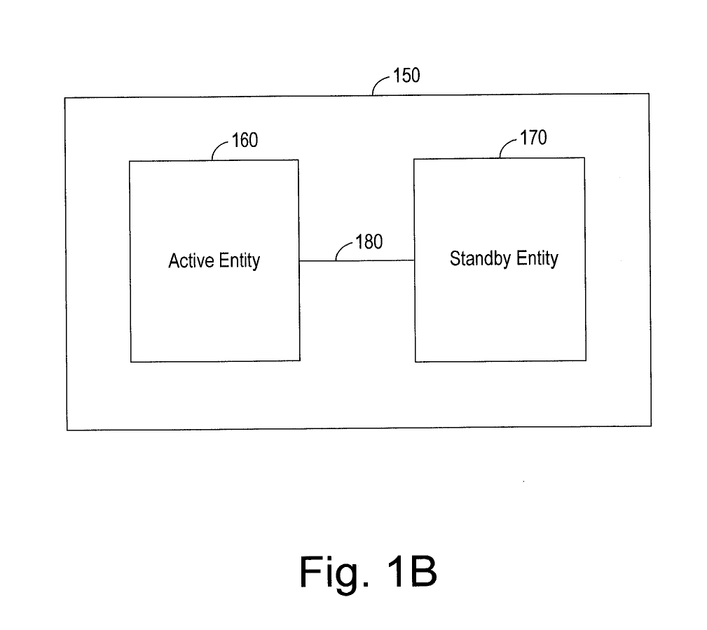

FIG. 1A illustrates a computing system 100, in accordance with some embodiments of the invention. Computer system 100 includes an active entity 110 and a standby entity 120. In some embodiments, the active entity 110 and the standby entity 120 may be located physically close together and may be connected to each other through, for example, a direct link 130 (e.g., a bus). In some embodiments, the active entity 110 and the standby entity 120 are located physically distant from each other and may be connected through a network (e.g., the Internet). In either case, the link 130 may be in any form that allows for a message communication channel between the active entity 110 and the standby entity 120.

In some embodiments of the invention, the active entity 110 establishes a connection to the standby entity 120 over link 130. After this connection, the active entity 110 and the standby entity 120 are able to exchange messages.

Active entity 110 and standby entity 120 may be any special or general purpose computer, such as an Intel® Pentium®4-based computer, available from a variety of third parties, an UltraSparc™ Ile-based workstation, available from Sun Microsystems, Inc. of Mountain View, Calif., an RS/6000 workstation, available from IBM of New York, a PowerPC™ G4 computer, available from Apple Computer, Inc. of Cupertino, Calif., a handheld device or appliance, available from a variety of third parties, etc.

FIG. 1B illustrates a computing system 150, in accordance with some embodiments of the invention. Computing system 150 may be, for example, a base station, that includes an active entity 160 and a standby entity 170 connected via a link 180. The active entity 160 and the standby entity 170 may be boards or cards inserted into expansion slots of a motherboard. The active entity 160 and the standby entity 170 may be connected through an asynchronous transfer mode (ATM) switch.

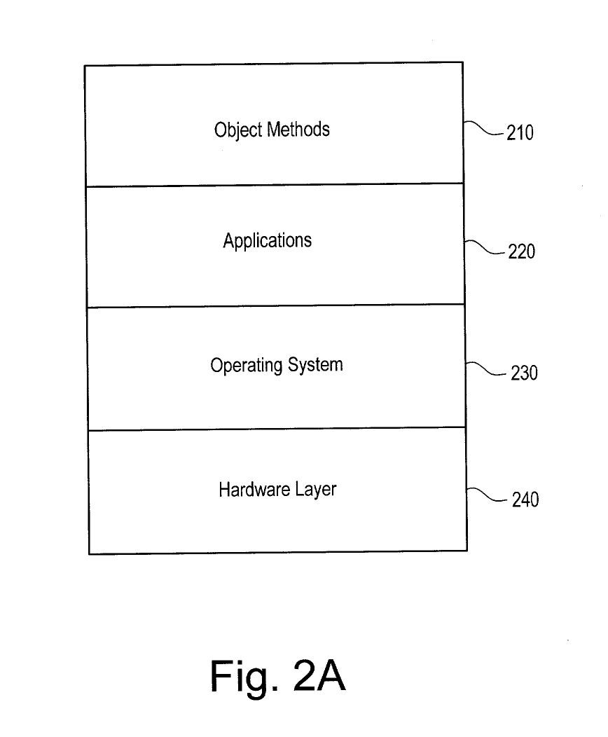

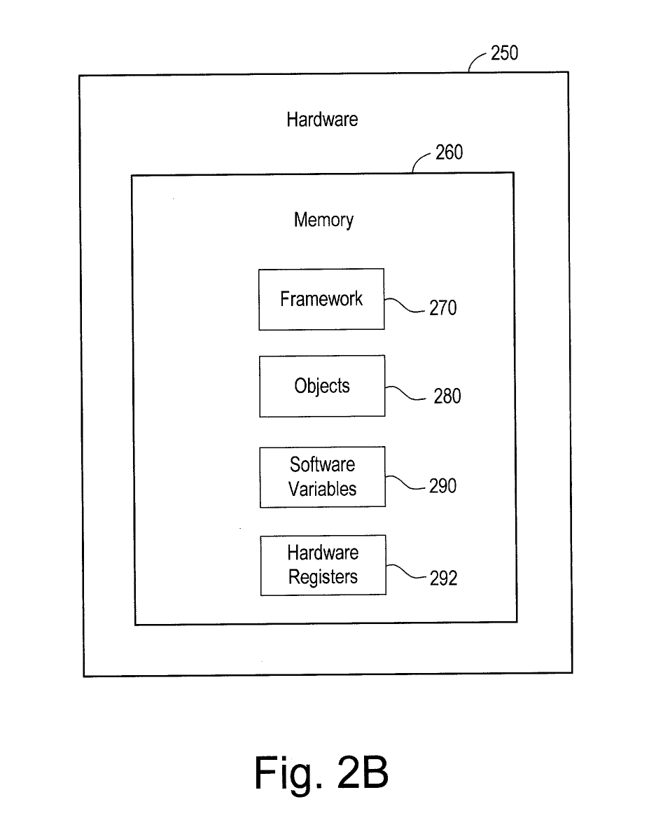

FIG. 2A illustrates the software structure of an active entity 110 or 160 and a standby entity 120 or 170, in accordance with some embodiments of the invention. During operation of entities 110, 120, 160, or 170, object methods 210 and application programs 220 are executed on top of operating system 230, which in turn controls hardware layer 240. An application program 220 can be a program that accomplish specific tasks, for example, a word processing program, a database management program, or a spreadsheet program. Application programs 220 create application objects that include attributes, rather than creating the attributes themselves. An object method 210 can be one or more operations or methods that can use or affect the data of an object, in object-oriented design or programming. Objects are the principal building blocks of object-oriented programs, and can be programming items that group together a data structure (instance variables) and operations (methods). Operating system 220 may be any suitable operating system for active and standby entities 110 and 120, such as Windows® 98, Windows® NT 4.0 or Windows® XP, available from Microsoft Corp. of Redmond, Wash., Mac® OS X, available from Apple Computer, Inc., any version of the Unix® operating system, etc. Hardware layer 240 provides a physical connection to link 180.

FIG. 2B illustrates a logical depiction of a portion of an exemplary hardware structure of the active entity 110 and the standby entity 120, in accordance with some embodiments of the invention. The hardware 250 includes a memory 260. The memory 260 includes a framework 270, objects 280, software variables 290, and hardware registers 292. Framework 270 provides classes or types of objects 280 having the same properties, operations, and behavior. Framework 270 may also include rules for how an application program 220 may create its own classes. The software variables 290 and hardware registers 292 may be updated using methods of objects 280 instantiated from classes in framework 270.

In various embodiments of the present invention, a system, method, and article of manufacture are provided for a transparent variable state mirroring. The transparent variable state mirroring allows for hot standby redundancy support between entities. This is accomplished by providing a protocol and a supporting software architecture for an object-oriented messaging scheme used to maintain data synchronization between an active entity 110 or 160 and a standby entity 120 or 170. As a result, the system, method, and article of manufacture, according to embodiments of the present invention, allow an application program 220 executed by an active entity 110 or 160 to manipulate (e.g., create, delete or update) application objects that contain state information (e.g., variables) on the active entity. When an application object is manipulated (e.g., created, deleted or updated), information is automatically transmitted via the messaging scheme from the active entity 110 or 160 to a standby entity 120 or 170 to update a corresponding application object on the standby entity. There is no longer a need to insert special code in application programs 220 that change variable values, thereby overcoming limitations of the prior art.

According to embodiments of the present invention, various attributes of objects may be mirrored between active entity 110 or 160 and standby entity 120 or 170. With the transparent variable state mirroring, all attributes that are to be mirrored are created using explicit (non-default) constructors. In one embodiment, these attributes to be mirrored may be derived from a special “mirrored” base class (e.g., AppAttrBase 350 described below), which is provided for elementary attributes (e.g., integers, characters, strings, etc.) that could be packaged for transport over a communication channel.

Using the elementary attributes, application programs 220 may construct more complicated structures which can be, for example, application objects of particular application classes. Application objects instantiated from these application classes are not created by a traditional new operator. Instead, such an application object is created through a Create( ) method of an associated application Factory class. The term “Factory” refers to a pattern in which objects of a class are created or deleted without using traditional operators (e.g., a new operator), but instead are created or deleted using, for example, a AppClassBase ( ) method or an int Delete(AppClassBase *) method of another class (e.g., FactoryBase class 310 as described herein). In this manner, one interface (i.e. FactoryBase class 310) may be used by an application program 220 to explicitly create/delete objects on an active entity that are mirrored on a standby entity.

The attributes to be mirrored are assigned unique identifiers. These identifiers are unique within an application software image and are reusable between different entities running instances of the software including the classes, even if different versions of the software are run on different entities (e.g., different versions of the software may run on the active entity 110 or 160 and the standby entity 120 or 170). Attribute identifiers are used to uniquely identify each attribute of concern for redundancy mirroring communication between redundancy peers (e.g., active and standby entities). Each identifier consists of three parts: a class identifier (CLASS_ID), an attribute identifier (ATTRIBUTE_ID), and an application object identifier (OBJECT_ID). The CLASS_ID identifies an application class and the corresponding application Factory class and application Factory object (by which the corresponding application objects are created). In some embodiments, the CLASS_ID is a number generated from the application Factory class name. The ATTRIBUTE_ID identifies the attribute within the application class. In some embodiments, the ATTRIBUTE_ID is a number generated from the attribute name within the application class. Since the ATTRIBUTE_ID has Factory related significance within a class, attribute names may be repeated in different classes, but the transparent variable state mirroring system has the ability to uniquely recognize them. The OBJECT_ID identifies the ordinal number of the application object within the collection of same class objects (e.g., like an array index).

For example, there may be many T1 interfaces in the system. Each T1 interface is defined by its T1_Interface class (i.e. application class). T1_Interface objects (i.e. application objects instantiated from the T1_Interface class) are created via a T1_interfaceFactory class (i.e. an application Factory class) that is derived from FactoryBase class 310 (as described in more detail below). The T1_Interface class has an attribute NumOfUsedSlots of type AttrInt integer that defines the number of used slots on the T1 interface. In this case, CLASS_ID identifies the T1_Interface class and corresponding T1_InterfaceFactory object, ATTRIBUTE_ID identifies the NumOfUsedSlots attribute, and OBJECT_ID identifies the ordinal number of the T1_Interface object.

When the attributes are created, they invoke the Attribute Base constructor, which registers particular attribute instances with an application object. The application object registers itself and its attributes with the application Factory object. The attributes of an application class are registered with the application Factory object the first time that an application object of the application class is created. Registration of attributes is done by the attribute providing its ATTRIBUTE_ID and its relative displacement inside the application object to the application Factory object.

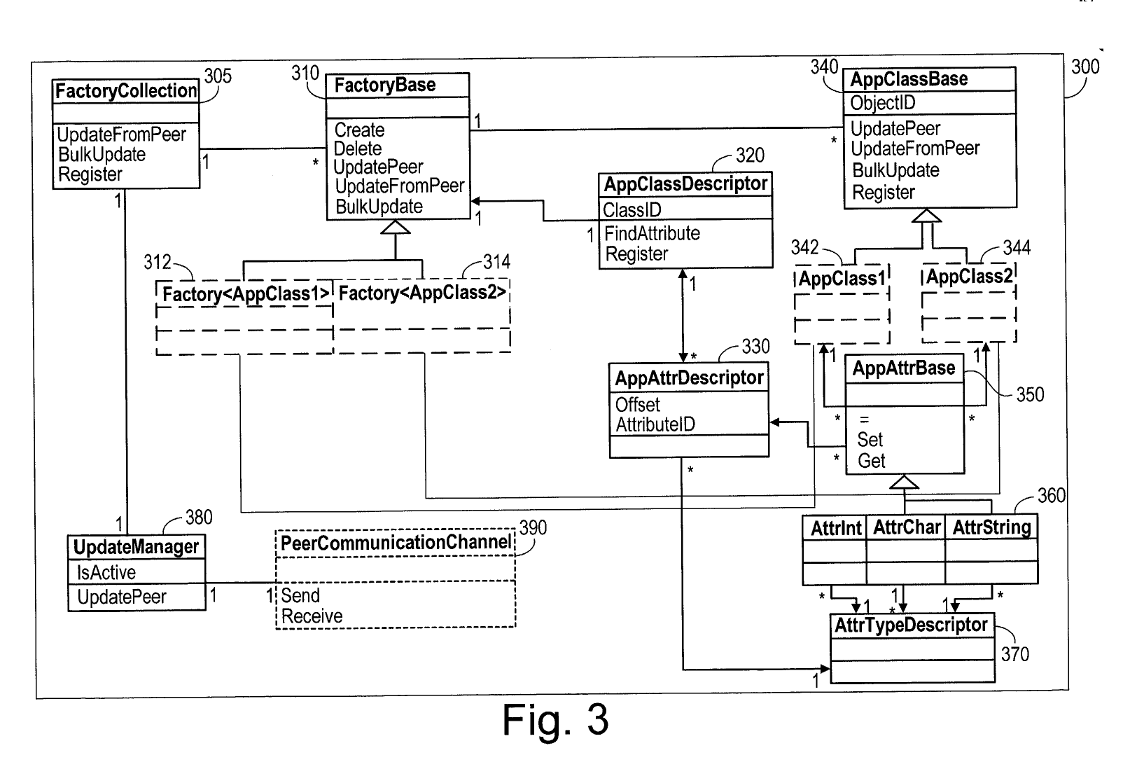

FIG. 3 illustrates a class hierarchy 300 provided by a transparent variable state mirroring system and method, in accordance with some embodiments of the invention. In FIG. 3, classes that are provided by framework 270 are depicted in solid outline (e.g., Factory Collection class 305, FactoryBase class 310, AppClassDescriptor class 320, AppAttrDescriptor class 330, AppAttrBase class 350, AttrInt/AttrChar/AttrString class 360, AttrTypeDescriptor class 370, and Update Manager class 380). Examples of classes that an application program developer may add based on framework 270 are depicted in dashed outline (e.g., Factory<AppClass1> 312, Factory<AppClass2> 314, AppClass1 342, AppClass2 344). Examples of classes that may be provided by operating system 230 are depicted in dotted outline (e.g., PeerCommunicationChannel class 390).

Within each class, a bar is used to separate member data from methods of the class (e.g., within AppClassDescriptor class 320, data CLASS_ID is separated by a bar from methods FindAttribute( ) and Register( )). Objects are instantiated from the classes, and, for simplicity, are given the same name as the class name. For example, an object instantiated from FactoryCollection class 305 is referred to herein as a FactoryCollection object. In some embodiments, the object-oriented design relies, in part, on class inheritance and method overloading.

FactoryCollection class 305—which is part of framework 270 provided by the transparent variable state mirroring—is a root class that contains references (e.g., pointers) to all application Factory objects that were created by an application program 220. In some embodiments, FactoryCollection class 305 may not be modified by the application program developer. In some embodiments, FactoryCollection class 305 includes an UpdateFromPeer( ) method for processing updates at a standby entity 170 from an active entity 160, a BulkUpdate( ) method for transferring initial updates to a standby entity 170, and a Register( ) method for registering application Factory objects.

FactoryBase class 310 is an abstract, non-instantiable framework class that provides an interface and some implementation of Factory functionality. The Factory <AppClass> classes 312 and 314 inherit from FactoryBase class 310. A template <class AppClass>Factory provides a template for creation of application Factory classes (e.g., 312 and 314). In other words, application Factory classes 312 and 314 are instantiations of template <class AppClass>Factory, and the class hierarchy includes two such classes 312 and 314. In one embodiment, there is exactly one object (singleton) of each template instantiated application Factory class, such as one object of the Factory <AppClass1> class and one object of the Factory <AppClass2> class. Application Factory classes are instantiated by an application program with a new operator (e.g., new Factory<AppClass1>).

AppClassDescriptor class 320 is part of the framework and provides a description of an application class from the point of view of its mirroring properties. In particular, AppClassDescriptor class 320 contains a CLASS_ID and a list of all mirrored members' descriptors for the mirrored members of the class. The latter is represented as a one-to-many aggregation of AppAttrDescriptors class 330 into AppClassDescriptor class 320. AppClassDescriptor class 320 also includes a FindAttribute( ) method used for finding an attribute and a Register( ) method used for registering an attribute of an application class.

AppAttrDescriptor class 330 is part of the framework and provides a description of particular mirrored attributes within an application class. AppAttrDescriptor class 330 contains an AttributeID member that is unique within an application class and an Offset member that defines the memory location of this attribute within the application class. Each object of AppAttrDescriptors class 330 is associated with an object of an AttrTypeDescriptor class 370, which defines which type of attribute this attribute belongs to (e.g., AttrInt, AttrChar or AttrString). An object of AttrTypeDescriptor class 370 also contains an association with each of the objects of AppAttrDescriptor class 330 that is the descriptor for a particular member of an application class.

AppClassBase class 340 is the base class for application classes provided by framework 270. An application program developer derives application classes (e.g., 342 and 344) from AppClassBase class 310. AppClassBase class 310 includes an ObjectID (which identifies an application object), an UpdatePeer( ) method, an UpdateFromPeer( ) method, a BulkUpdate( ) method, and a Register( ) method. Application classes 342 and 344 may contain regular members (i.e., members that are not of type AppAttrBase class 350) and/or special attributes that are of type AppAttrBase class 350. For AppAttrBase class 350 type attributes, the mirroring behavior is automatically applied (e.g., when an assignment (“=”) operator is encountered, the standby entity is sent a message to perform an update of an attribute). The relationship between application classes and their members of type AppAttrBase is bidirectional aggregation.

In one embodiment, all AppClassBase objects are created through a particular inherited Factory. In other words, application objects (i.e., objects instantiated from application classes, such as AppClass1 342 and AppClass2 344) are not created by a traditional new operator. Instead, application objects are created with the Create( ) method of the associated application Factory class (e.g., 312 or 314). In particular, the application object is created with an AppClassBase*Create( ) method of FactoryBase class 310. The body of the Create( ) method in the template <class.AppClass> Factory of the framework 270 creates the instance of the corresponding application class with a new operator such as new AppClass( ). Likewise, the Delete( ) method is used to delete an application object, instead of a traditional deconstructor. This provides interception of object “creation/deletion operations for mirroring” in addition to “attribute update” mirroring.

The application objects are registered in a Factory object after the Create( ) method is used for creation of new application objects (and attributes as a consequence). Each application class has a corresponding application Factory object. Each application Factory object is a single instance of the corresponding application Factory class. Each application Factory class 312 and 314 is derived from a base FactoryBase class 310 that provides a basic functionality of the Create( ) and Delete( ) methods, while the application program can add specific behavior through an inheritance. The application Factory object also maintains a collection of application objects and attributes within those application objects.

A FactoryBase object contains a collection of pointers to all AppClassBase objects created through a particular inherited Factory. This fact is represented by a one to many association (i.e., 1→*) of FactoryBase class 310 to AppClassBase class 340 in FIG. 3. Thus, a Factory <AppClass1> object contains a collection of pointers to all objects of AppClass1 class 342, while a Factory <AppClass2> object contains a collection of pointers to all objects of AppClass2 class 344. FactoryBase class 310 also contains (i.e., aggregates) one member that is an AppClassDescriptor class 320.

AppAttrBase class 350 is part of the framework 270 and provides a base class for all the basic attribute types that correspond to basic language types (e.g., int, char, short, string). In other words, class AppAttrBase 350 is provided for elementary types (e.g., AttrInt, AttrChar, and AttrString). All the attributes to be mirrored are derived from AppAttrBase class 350. AppAttrBase class 350 includes Assignment operator (represented by an equal sign (“=”)), Set( ), and Get( ) methods. For example, AttrInt class is derived from AppAttrBase class 350 and contains an integer value as its value and all of the necessary behavior for mirroring. Each of the objects of AttrX (e.g., AttrInt, AttrChar or AttrString) contains an association to one of the objects of AttrTypeDescriptor class 370 that defines the attribute type.

UpdateManager class 380 is part of the framework 270 and provides an interface through which all mirroring is done. UpdateManager class 380 includes an IsActive attribute that indicates whether this entity is active or standby and an UpdatePeer( ) method. Responsibilities of UpdateManager class 380 on the active entity may include putting all requests for updates into a list and, at a convenient time (e.g., at low priority task scheduling), converting the list of updates into a message, and transferring the message. The UpdateManager class includes methods for transferring the message through a method of a PeerCommunicationChannel class 390 to a peer entity (e.g., from an active entity to a standby entity). On the standby entity, the UpdatePeer( ) method of UpdateManager class 380 receives messages from a peer, decodes them, and translates them into update requests for the UpdateFromPeer( ) method of FactoryCollection class.

In some embodiments, PeerCommunicationChannel class 390 is not part of the framework 270, but rather is supplied by an operating system 230 for communication with another PeerCommunicationChannel class (e.g., at a peer entity). The PeerCommunicationChannel class 390 provides basic messaging communication capabilities. In particular, PeerCommunicationChannel class 390 includes a Send( ) method for transferring messages and a Receive( ) method for receiving messages.

With embodiments of the present invention for transparent variable state mirroring, simply creating an object or updating an attribute at the active entity automatically performs the same function at the standby entity. The transparent variable state mirroring system also improves the implementation of both the initial update and run-time update tasks as no special code is needed for each new component (e.g., a set of associated classes in software) that requires mirroring.

Usually application objects do not exist separately, but they are connected to each other by way of, for example, pointers. When an application program creates, for example, two application objects, the application program may associate them by assigning pointers from a first application object to a second application object via members of the first and second application objects. In this manner, multiple application objects may include references to each other.

When application objects are created automatically on a standby entity as a replication of the application object on the active entity, the transparent variable state mirroring provided by systems and methods of the present invention may create an association between the application objects in the following way.

In some embodiments, to enable application objects to point to each other, each application object contains an OBJECT ID identifying the other application object. The OBJECT_ID is an attribute that is used in addition to, or instead of, pointers. In this case, application objects find each other by translating OBJECT_IDs to pointers or references before actual access. An application program assigns the OBJECT_ID member attributes of the application objects on the active entity to the values that the application program wants when the application program associates the application objects, and these attributes are propagated as any other mirrored attribute to the standby entity, and therefore make the same association there.

Such functionality may be implemented with a pointer class, AttrPointer, that is derived from AttrInt class. AttrPointer class contains the “real” non-mirrored pointer in addition to the OBJECT_ID that is contained as an integer value of the mirrored AttrInt class. The “assignment” operator and Set( ) method of AttrPointer class are overloaded so that application program code may calculate the “real” pointer based on the OBJECT_ID mirrored value and then may call AttrInt class implementation of the Set( ) method. The application program can use the AttrPointer attribute to get the pointer to the associated object, for example, by overloading the “->” operator (the dereferencing operator) or by calling a Pointer( )->method.

When the attributes are updated one by one, it is possible that at some moment, the set of attributes at the active and standby entities have inconsistent values, with only some of them being updated. If the redundancy switch happens exactly at that time, the standby entity may start working with an inconsistent set of values.

Therefore, with the transparent variable state mirroring, the UpdateManager object on the active entity runs as a low priority task. The application program that is updating attributes runs as a higher priority task. As a result, the UpdateManager object runs and transfers a message to the standby entity only after an application program has finished updating all attributes in a set. On the standby entity, the UpdateManager object runs as a higher priority task so that no other task can interrupt the UpdateManager task while it is updating attributes in a set.

In some embodiments, the UpdateManager object is able to determine that one attribute was modified multiple times while a set of attributes were being processed, and, in this case, the UpdateManager object is able to transfer the most recent update value to the standby entity.

In some embodiments, the application program behavior sometimes requires changes in software attributes to be propagated to hardware registers, so that some values in hardware change too. These hardware register assignments usually cannot be intercepted like software attributes and propagated to the standby entity. The hardware registers may be updated by deriving a class from the corresponding attribute class (e.g., AttrInt) and overloading its assignment operator and Set( ) methods so that the overloaded Set( ) method writes into the corresponding register and then calls the Set( ) method of the base AttrInt class. This approach can also be used when update of any non-mirrored variables from mirrored variables is required (i.e., computed values as opposed to mirrored values).

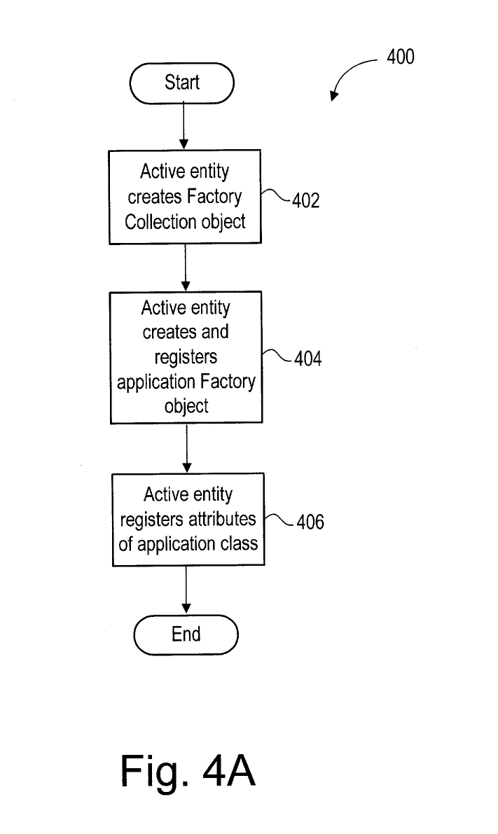

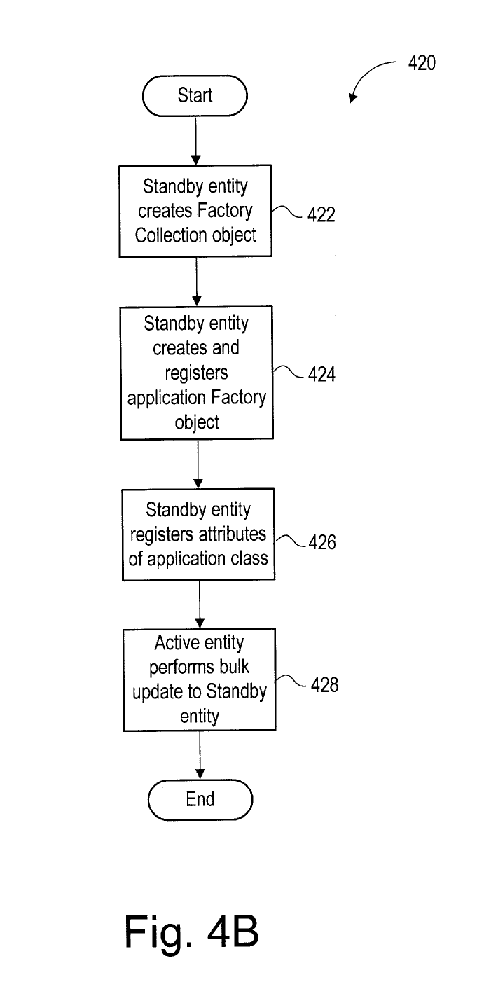

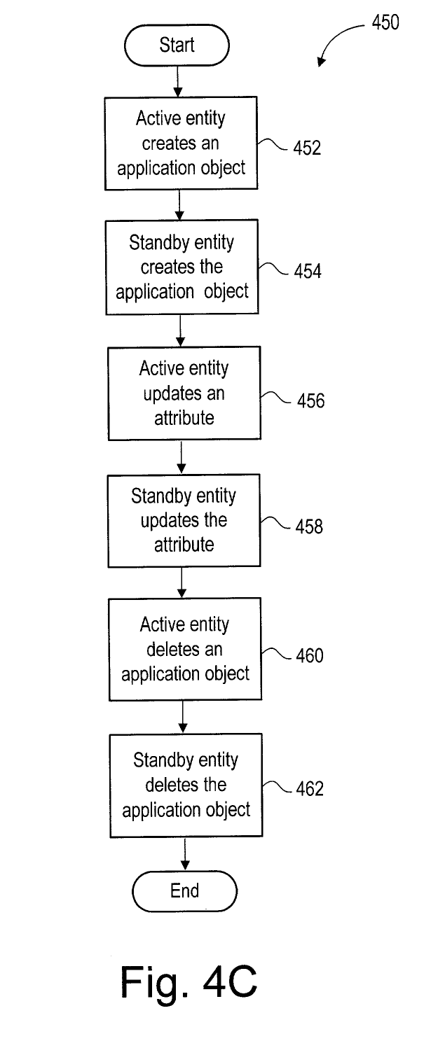

More details of operations for supporting or implementing transparent variable state mirroring are provided below with reference to FIGS. 4A, 4B, 4C, 5, 6, 7, 8, 9, 10, and 11.

FIGS. 4A, 4B, and 4C are flow diagrams of operations 400, 420, and 450, respectively, of use of the class structure of FIG. 3, in accordance with some embodiments of the invention.

FIG. 4A is a flow diagram of an operation 400 for active entity initialization, in accordance with some embodiments of the invention. In some embodiments, operation 400 may be performed by an active entity 110 or 160. Operation 400 may start with the active entity 110 or 160 creating a Factory Collection object (stage 402). The active entity 110 or 160 creates and registers application Factory objects (stage 404). The active entity 110 or 160 registers attributes of an application class (stage 406). Registration of application Factory objects with the FactoryCollection object takes place automatically when the application Factory objects are created using a base class constructor (e.g., a new operator) of the FactoryBase object. Thereafter, operation 400 ends.

FIG. 4B is a flow diagram of an operation 420 for standby entity initialization, in accordance with some embodiments of the invention. In some embodiments, operation 420 may be performed by a standby entity 120 or 170. Operation 420 begins with standby entity 120 or 170 creating a Factory Collection object (stage 422). The standby entity 120 or 170 creates and registers application Factory objects (stage 424). The standby entity 120 or 170 registers attributes of an application class (stage 426).

A bulk update to the standby entity 120 or 170 is then performed (stage 428), for example, by the active entity 110 or 160. Bulk update may transfer current variable states to the standby entity in one or more messages. The active entity 110 or 160 performs a bulk update (stage 428) so that the standby entity 120 or 170 receives a copy of the application objects that have been created at the active entity. For initial update, the BulkUpdate( ) method of the FactoryCollection object in the active entity 110 or 160 goes through all the registered application Factory objects and application objects created by those application Factory objects. For each application object, a Create( ) command is sent to the standby entity 120 or 170 with the application object's class CLASS_ID, OBJECT_ID, and the set of attributes that are registered in the application Factory object with their snapshot values taken from the application object. In particular, for each attribute, an entry is made in the message that contains the ATTRIBUTE_ID and value.

The standby entity 120 or 170 receives redundancy mirroring messages and decodes them. There could be two types of entries in the message—a Create/Delete entry or an attribute update entry. When a Create( ) command is received, the FactoryCollection object at the standby entity tries to find the application object according to CLASS_ID and OBJECT_ID. If CLASS_ID is not found, then this application class is not supported by the running version of the software on the standby entity 120 or 170 and the Create( ) command is discarded. If CLASS_ID is found, but OBJECT_ID for this CLASS_ID is not found, then the application object with the corresponding OBJECT_ID is created by calling (i.e., invoking) the Create( ) method of the corresponding application Factory object. If OBJECT_ID is found as well, this means that the application object has been created already so an error is reported and the Create( ) command is ignored.

Next, for each attribute entry in the message, the BulkUpdate( ) method tries to find the attribute according to its ATTRIBUTE_ID identifier in the list of all attributes registered with corresponding application Factory object. If the attribute is not found according to its ATTRIBUTE_ID, the version of the software on the standby entity 120 or 170 does not support this attribute within this class, and the attribute is discarded. If the attribute is found by its ATTRIBUTE_ID, then the value from the message is assigned to this attribute within the corresponding application object that is identified by its CLASS_ID and OBJECT_ID.

When the standby entity 120 or 170 is started (e.g., if the standby entity is a card and is inserted into a motherboard) and initial bulk update is being sent from the active entity 110 or 160 to the standby entity, some attributes may change state during the bulk update. Therefore, the transparent variable state mirroring system caches changes at the active entity 110 or 160 until the bulk update is finished. Then the changes are sent to the standby entity 120 or 170. In addition, the bulk update is performed from application object copies that are “frozen” when the bulk update starts, rather than from the application objects themselves because they may be changed during the bulk update process. Operation 420 then ends.

FIG. 4C is a flow diagram of an operation 450 for an update phase in which an application program 220 is executing, in accordance with some embodiments of the invention. In some embodiments, operation 450 may be performed by the active entity 110 or 160 and the standby entity 120 or 170.

Referring to FIG. 4C, operation 450 may begin with an application program 220 at an active entity 110 or 160 creating an associated application object (stage 452). Each application class (e.g., 342 or 344) has a corresponding application Factory class (e.g., 312 or 314). The application Factory class (e.g., 312 or 314) includes a Create( ) method for creating application objects of the application class, and a Delete( ) method for deleting the application objects. On the active entity 110 or 160, the first registration of an application object takes place when an application program 220 creates the first application object of the corresponding application class by calling the Create( ) method of the corresponding application Factory object. The run-time creation of an object on the active entity 110 or 160 is triggered when an application program creates a new application object of the corresponding application class by calling the Create( ) method of the corresponding application Factory object. The Create( ) method of the derived application Factory class calls a Create( ) method of FactoryBase class 310. The Create( ) method of the base class takes care of transferring the Create( ) command with CLASS_ID and OBJECT_ID of the object created to the standby entity 120 or 170.

The standby entity 120 or 170 creates a corresponding application object (stage 454). On the standby entity, the first registration takes place when the first object creation command is received from the active entity and the Create( ) method is called on the corresponding application Factory object.

In one embodiment, the standby entity 120 or 170 receives the message, decodes the message, and calls the Create( ) method of the corresponding application Factory object. The Create( ) method creates the application object with corresponding OBJECT_ID and registers the application object with the application Factory object. After registration, the application object can be found when attribute updates occur. Object deletion is performed in a similar fashion.

The application program 220 at the active entity 110 or 160 may update an attribute of an application object (stage 456). The run-time update may occur when an application program on the active entity changes an attribute using the assignment operator. The update is intercepted by a virtual method (i.e. the Assignment (“=”) method) of AppAttrBase class. The assignment method then automatically (without the application program knowing about it) adds the attribute with its identifier (CLASS_ID+ATTRIBUTE_ID+OBJECT_ID) to a list of attributes to transfer to the standby entity. Then when the UpdateManager object is scheduled to transfer a message to the standby entity, the UpdateManager object transfers all the attributes to be updated to the standby entity. Then the standby entity updates a corresponding attribute (stage 458) of a corresponding application object. The standby entity decodes each attribute entry in the message. If the CLASS_ID or ATTRIBUTE_ID within the corresponding application Factory object is not found, then the application Factory object or the attribute is not supported by the software version, and this entry in the message is discarded. If the attribute is not found by its OBJECT_ID, the software may have an error in synchronization behavior. In this case, the error is logged, and this entry in the message is discarded. If the attribute is found, the value from the message is assigned to the actual attribute on the standby entity.

In this manner, the active and standby entities maintain the same state, and the standby entity can take over processing from the active entity.

In some embodiments, the application program at the active entity 110 or 160 may delete an application object (stage 460). In particular, an application object is deleted at the active entity when the application program calls the Delete( ) method of the application Factory object.

In such cases, the standby entity 120 or 170 also deletes a corresponding application object (stage 462) upon receipt of a deletion message from the active entity. When a Delete( ) command is received at the standby entity, the FactoryCollection object at the standby entity tries to find the application object to be deleted according to its CLASS_ID and OBJECT_ID. If CLASS_ID is not found, then this application class is not supported by the running version of the software on the standby entity and the Delete( ) command is discarded. If CLASS_ID is found, but OBJECT_ID for this CLASS_ID, is not found then the application object with the corresponding OBJECT_ID does not exist, so an error is reported and the Delete( ) command is discarded. If OBJECT_ID is found as well as CLASS_ID, then the application object is being deleted. Operation 450 then ends.

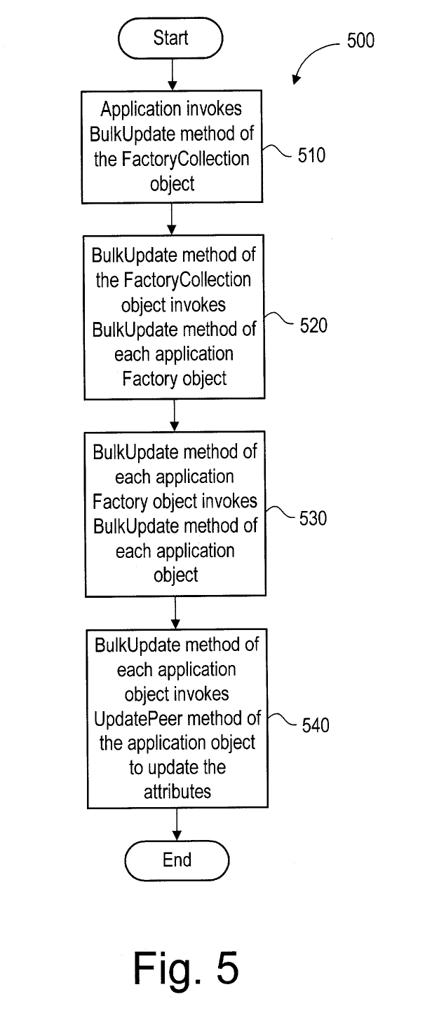

FIG. 5 is a flow diagram of an operation 500 for bulk update, in accordance with some embodiments of the invention. Initially, an application program 220 at the active entity 110 or 160 invokes the BulkUpdate( ) method of the FactoryCollection object, which is instantiated from FactoryCollection class 305 (stage 510). The BulkUpdate( ) method of the FactoryCollection object iterates through all of the application Factory objects that are registered, calling the BulkUpdate( ) method of each application Factory object (instantiated from an application Factory class, such as 312 or 314, which was instantiated from FactoryBase class 310) (stage 520).

The BulkUpdate( ) method of an application Factory object iterates through all of the registered application objects (instantiated from an application class, such as 342 or 344, which was instantiated from an AppClassBase 340) of the class that the application Factory object handles, calling the BulkUpdate( ) method of each application object (stage 530).

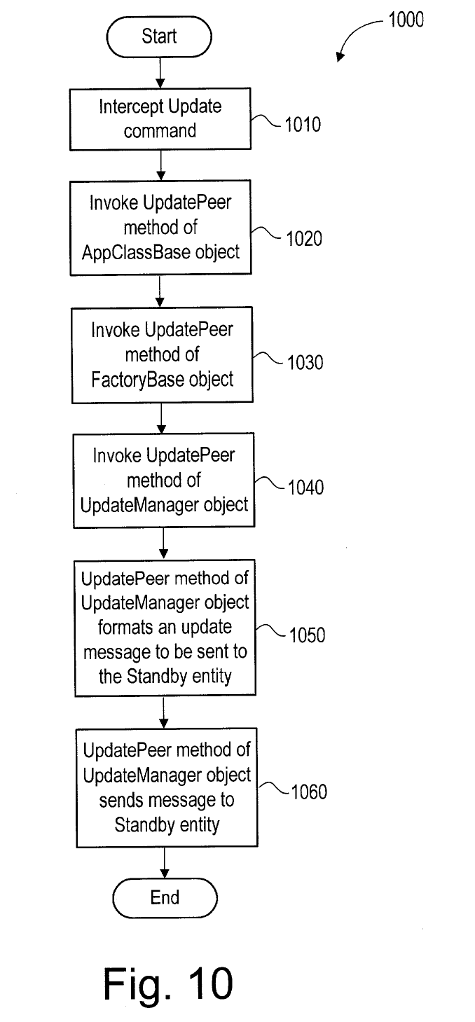

The BulkUpdate( ) method of each application object invokes the UpdatePeer( ) method of the application object to update the peer entity (stage 540). In particular, the BulkUpdate( ) method of the application object goes through the list of all of the attributes that belong to that application object using an AppClassDescriptor class 320 link through FactoryBase class 310 and, using the Offsets member of AppAttrDescriptor class 330, makes copies of attributes and calls the UpdatePeer( ) method. The UpdatePeer( ) method is further described with respect to FIG. 10. Operation 500 then ends.

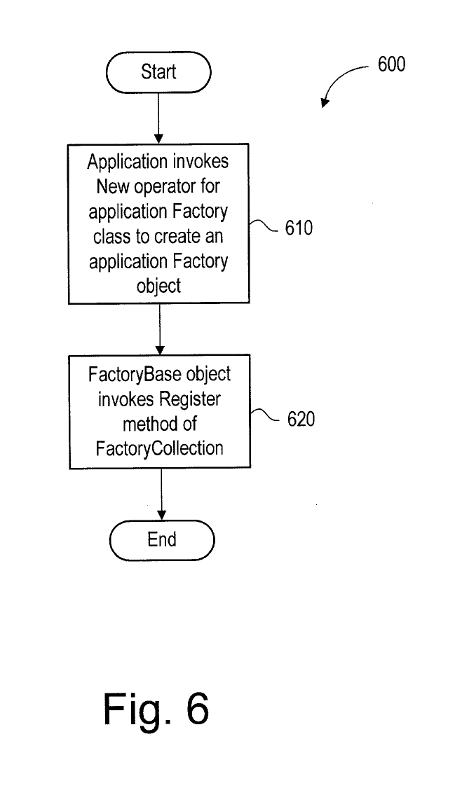

FIG. 6 is a flow diagram of an operation 600 for application Factory registration, in accordance with some embodiments of the invention. Initially, the application program 220 on the active entity 110 or 160 calls a new operator to generate an application Factory class (e.g., Factory<AppClass1> 312) (stage 610). Then a constructor of the FactoryBase class calls the Register( ) method of the FactoryCollection object to register the application Factory class (stage 620). Thereafter, operation 600 ends.

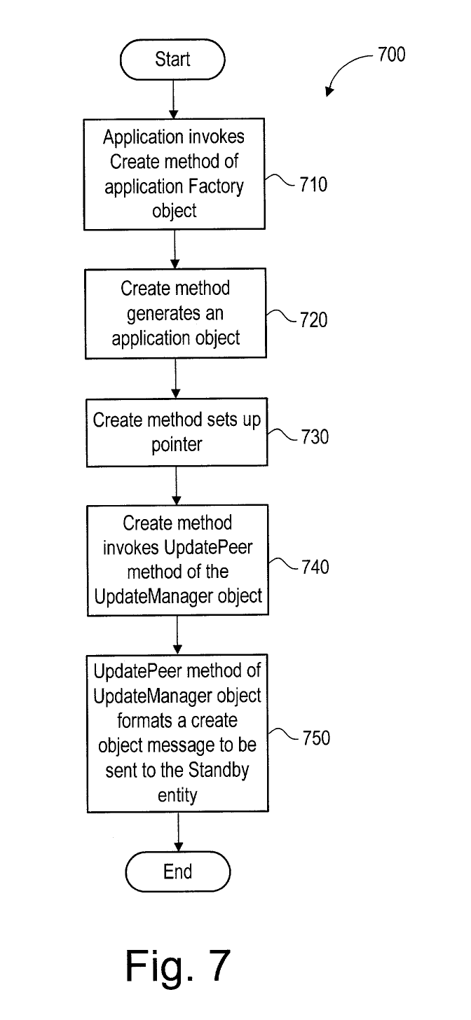

FIG. 7 is a flow diagram of an operation 700 for application object creation on the active entity, in accordance with some embodiments of the invention. The application program 220 on the active entity 110 or 160 creates an application object by calling the Create( ) method of a particular application Factory object (e.g., Factory<AppClass1>) (stage 710). The Create( ) method causes creation of an application object (e.g., AppClass1 object of AppClass1 class 342) by calling a new operator on the AppClass1(ObjectID) class 342. The ObjectID is automatically created by the application Factory object, if the ObjectID is not supplied by the application program 220 (i.e., this is the default case) (stage 720).

The Create( ) method also adds the pointer of the newly created application object to the application Factory object's association list of ObjectIDs with a pointer to the application object (stage 730), which registers the application object with the application Factory object. The Create( ) method calls the UpdatePeer(CLASS_ID, ObjectID) method of the UpdateManager object (instantiated from UpdateManager class 380) (stage 740). The UpdatePeer(CLASS_ID, ObjectID) method of the UpdateManager object formats a create message for object creation that includes the CLASS_ID and ObjectID (stage 750). This message is sent to the standby entity via the PeerCommunicationChannel object.

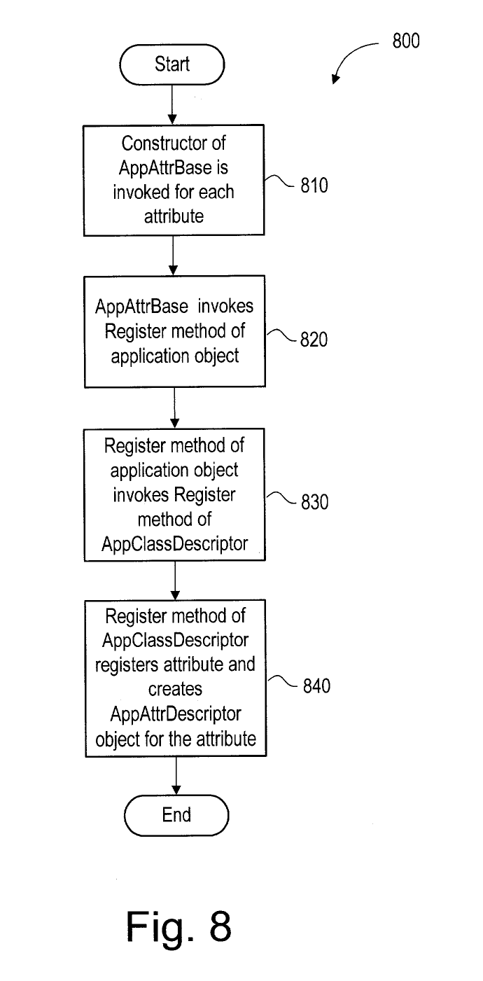

FIG. 8 is a flow diagram of an operation 800 for attribute registration, in accordance with some embodiments of the invention. When the application program 220 at the active entity 110 or 160 calls the Create( ) method of an application Factory object (e.g., on Factory<AppClass1>object) for the first time, the processing described in reference to FIG. 7 occurs. Additionally, a constructor of the AppAttrBase object is called for each attribute of the application object (stage 810). For example, AppAttr1 of type AttrInt may be an attribute of the AppClass1 object. The constructor includes an attribute identifier (e.g., AttributeID) parameter and a pointer to the application object itself (e.g., AppAttr1(AttributeID, pointer)).

A constructor of the AppAttrBase object (instantiated from AppAttrBase class 350) calls the Register(AppAttrBase *) method of the application object (e.g., AppClass1 object) through the pointer parameter (stage 820). A pointer to the attribute is supplied as a parameter. The Register( ) method of the application object calculates the Offset of the attribute within the class by subtracting the pointer to the object from the pointer to the attribute supplied as a parameter. With this information, the Register( ) method of the application object then goes to the AppClassDescriptor object (via a link to FactoryBase) and calls the Register(AttributeID, Offset) method of the AppClassDescriptor object (stage 830).

The Register( ) method of the AppClassDescriptor object adds an association of the AttributeID and Offset into its registry list and creates a corresponding AppAttrDescriptor object (stage 840). This operation is repeated for each attribute belonging to the application object (e.g., AppClass1 object). Operation 800 then ends.

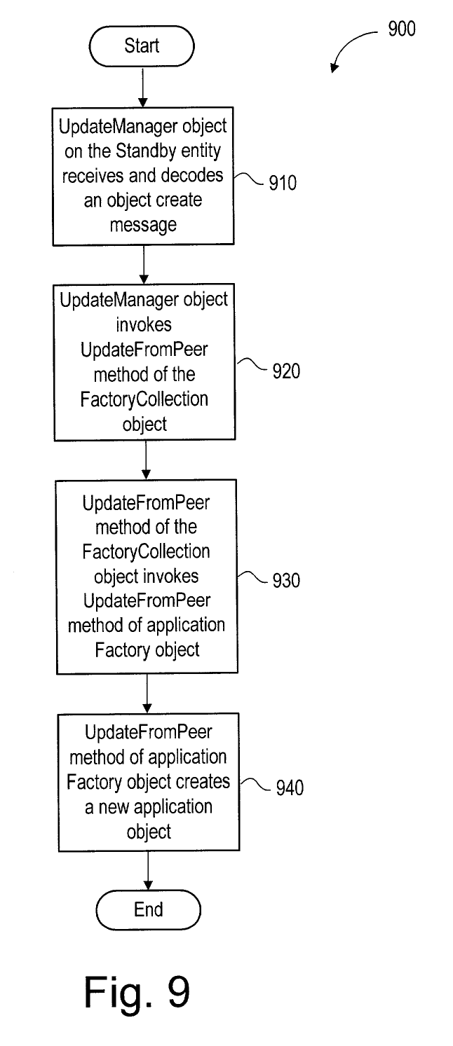

FIG. 9 is a flow diagram of an operation 900 for application object creation on the standby entity 120 or 170, in accordance with some embodiments of the invention. The UpdateManager object on the standby entity receives a message from the PeerCommunicationChannel object by calling the Receive( ) method.

The UpdateManager object decodes the message by extracting the CLASS_ID and ObjectID from the message (stage 910). The UpdateManager object then calls the UpdateFromPeer(CLASS_ID, ObjectID) method of the FactoryCollection object (stage 920).

The FactoryCollection object associates CLASS ID with a certain application Factory object (i.e. Factory<AppClassX> object) and calls the UpdateFromPeer (ObjectID) of that application Factory object (stage 930). The UpateFromPeer( ) method of the application Factory object (i.e. Factory<AppClass1> object) creates a new application object (e.g., of AppClass1 class 342) by calling the new operator (e.g., on AppClass1(ObjectID)) and associating a pointer to that application object with ObjectID (stage 940). Operation 900 ends thereafter.

FIG. 10 is a flow diagram of an operation 1000 for update on the active entity 110 or 160, in accordance with some embodiments of the invention. Initially, an attribute update command is intercepted (stage 1010). For example, an AttrInt Attr1 member within an application object (e.g., instantiated from AppClass1 class 342) intercepts an assignment (“=”) operator with assignment of a new value.

In some embodiments, the IsActive attribute is queried by, for example, the Set( ) method of the AppAttrBase object to determine whether this entity is an active entity or a standby entity. If this entity is an active entity, then the attribute is updated and an update to an attribute is also sent to the standby entity. If this entity is a standby entity, then an update to an attribute has been received from the active entity, and the attribute is updated.

If it is determined that this is an active entity, then the attribute (e.g., Attr1) goes along its aggregation link with the application object (e.g., AppClass1 object) and calls the UpdatePeer(AppAttrBase) method of the AppClassBase object, providing a copy of itself as a parameter (stage 1020).

The application object (e.g., AppClass1 object) goes along the link to the application Factory object (e.g., Factory<AppClass1> object) and calls the UpdatePeer(AppAttrBase *, int ObjectID) method of the FactoryBase object, providing a pointer to the copy of the attribute (e.g., Attr1) and its own ObjectID value (stage 1030).

The UpdatePeer( ) method of the FactoryBase object reads the CLASS_ID from its AppClassDescriptor member, finds the attribute (e.g., Attr1) object, follows a link from the attribute object to the AppAttrDescriptor object, and derives an AttributeID from the AppAttrDescriptor object. Then the UpdatePeer( ) method of the FactoryBase object calls the UpdatePeer(CLASS_ID, AttributeID, ObjectID, AppAttrBase *) method of the UpdateManager object (stage 1040).

The UpdatePeer( ) method of the UpdateManager object stores all the parameters of the call into a list of requested updates. The UpdatePeer( ) method of the UpdateManager( ) object formats the CLASS_ID, AttributeID, and ObjectID into a message; then the UpdatePeer( ) method of the UpdateManager object goes to the attribute (e.g., Attr1) object, derives a value from the attribute object based on object type, and formats the value into a message (stage 1050). Next, the UpdatePeer( ) method of the UpdateManager object calls the Send(MsgBuf *) method of the PeerCommunicationChannel object to transfer the message to the standby entity (stage 1060). Operation 1000 then ends.

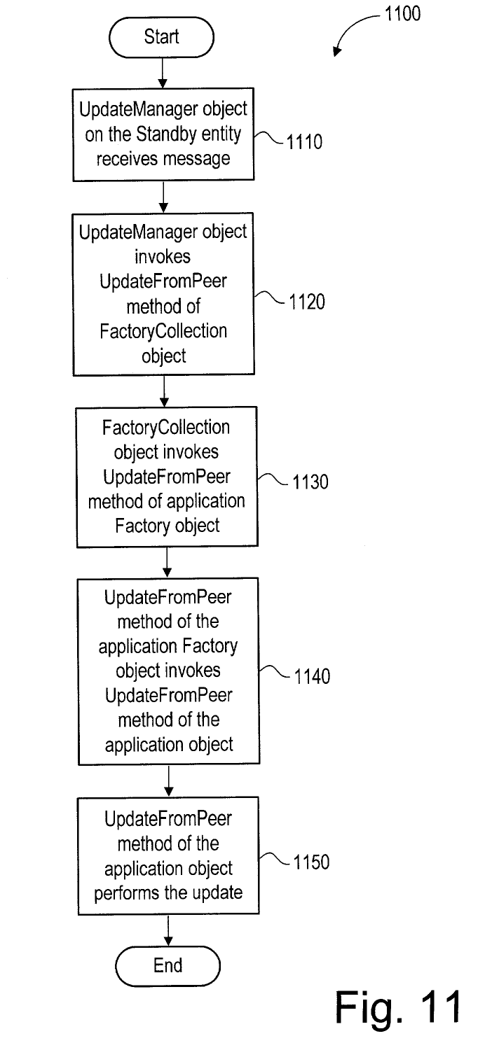

FIG. 11 is a flow diagram of an operation 100 for update on the standby entity 120 or 170, in accordance with some embodiments of the invention. The UpdateManager at the standby entity receives the message from the PeerCommunicationChannel object by calling MsgBuf *Receive( ) (stage 1110). The UpdateManager decodes the message and calls the UpdateFromPeer(CLASS_ID, AttributeID, ObjectID, AppAttrBase *) method of the FactoryCollection, providing class id, attribute id, and object id parameters and a pointer to the attribute object, defining attribute type and value (stage 1120).

The UpdateFromPeer( ) method of the FactoryCollection object associates the CLASS_ID parameter with a particular application Factory object that is responsible for handling application objects of the class identified by CLASS_ID. Then the UpdateFromPeer( ) method of the FactoryCollection object redirects the call to the UpdateFromPeer(AttributeID, AppAttrBase *) method of a specific application Factory object (e.g., Factory<AppClass1> object) (stage 1130). All parameters except CLASS_ID are the same in this call, and CLASS_ID is omitted because CLASS_ID is already decoded into a particular application Factory object.

The UpdateFromPeer( ) method of the application Factory object finds the association of the AttributeID with particular attribute characteristics (e.g., Offset) by using the FindAttribute( ) method of the AppClassDescriptor object. Then the UpdateFromPeer( ) method of the application Factory object associates an ObjectID with a pointer to a particular application object (e.g., AppClass1 object) and calls the UpdateFromPeer(Offset, AppAttrBase *) method of the application object (stage 1140).

The UpdateFromPeer( ) method of the application object first finds the pointer to the attribute by taking the Offset parameter and adding the Offset parameter to the pointer to the application object, which results in a new pointer. Then, using the new pointer, the UpdateFromPeer( ) method of the application object calls the Get( ) method of the AppAttrBase object to get the value from the arriving attribute and calls the Set( ) method of the AppAttrBase object to set the value into the attribute inside the application object (stage 1150). Thereafter, operation 1100 ends.

Embodiments of the invention may be carried out by software, firmware, or microcode operating on a computer or computers of any type. Additionally, software embodying the invention comprise computer instructions in any form (e.g., source code, object code, interpreted code) stored in any computer-readable medium (e.g., ROM, RAM, magnetic media, punched tape or card, compact disc (CD), DVD). Thus, the invention may be tangibly embodied as software in a computer-readable device or media, such as memory, data storage devices, and/or data communication devices, thereby making a product or article of manufacture according to the invention. As such, the terms “article of manufacture” and “computer program product” and “computer-readable storage medium” as used herein are intended to encompass software accessible from any computer-readable device or media. Furthermore, such software may also be in the form of a computer data signal embodied in a carrier wave, such as that found within the well-known Web pages transferred among computers connected to the Internet. Accordingly the present invention is not limited to any particular platform unless specifically stated otherwise in the present disclosure. Using the present specification, the invention may be implemented as a machine, process, or article of manufacture by using programming and/or engineering techniques to produce software, firmware, hardware, or any combination thereof.

Although the invention has been described with reference to particular embodiments, the description is only an example of the invention's application and should not be taken as a limitation. Furthermore, the order in which the steps of the present technique are performed is purely illustrative in nature. The stages in the flow diagrams described herein may be performed in any order or in parallel, unless otherwise indicated by the present disclosure.

Thus, while particular embodiments of the present invention have been shown and described, it will be apparent to those skilled in the art that changes and modifications may be made without departing from this invention in its broader aspect, and, therefore, the appended claims are to encompass within their scope all such changes and modifications as fall within the true spirit of this invention.

I claim:

1. A computer system for transparent mirroring; comprising:
an first entity connected to a second entity;
a computer program executable by the first entity, wherein the computer program comprises instructions for:
manipulating an application object, wherein manipulation of the application object automatically causes a message to be transmitted to the second entity requesting a corresponding manipulation of an application object to be performed at the second entity.

2. The computer system of claim 1, wherein the manipulation causes creation of an application object.

3. The computer system of claim 2, wherein the computer program further comprises instructions for:
invoking a Create method of an application Factory object to cause creation of the application object.

4. The computer system of claim 2, wherein creation of the application object causes registration of the application object with an application Factory object.

5. The computer system of claim 2, wherein creation of the application object causes registration of attributes of the application object.

6. The computer system of claim 1, wherein the manipulation causes deletion of an application object.

7. The computer system of claim 6, wherein the computer program further comprises instructions for:
invoking a Delete method of an application Factory object to cause deletion of the application object.

8. The computer system of claim 1, wherein the manipulation causes update of an attribute of the application object.

9. The computer system of claim 8, wherein the computer program comprises instructions for:
performing the update of the attribute with an assignment operator.

10. The computer system of claim 1, wherein the manipulation causes modification of a value of a hardware register.

11. The computer system of claim 1, wherein the computer program further comprises instructions for:
creating an application Factory class corresponding to the application object; and
registering the application Factory object with a FactoryCollection object.

12. The computer system of claim 1, wherein the computer program further comprises instructions for:
invoking a BulkUpdate method of a FactoryCollection object to cause one or more messages to be transmitted to the second entity.

13. The computer system of claim 1, wherein the message comprises one or more entries indicating a creation, deletion, or update of an application object.

14. The computer system of claim 1, wherein the first entity comprises an active computer and the second entity comprises a standby computer connected via a network.

15. The computer system of claim 1, wherein the first entity comprises a first board and the second entity comprises a second board connected via a bus.

16. The computer system of claim 1, wherein an attribute of the application object is identified by a class identifier, an attribute identifier, and an object identifier.

17. A computer system, comprising:
an entity;
a framework stored on the entity, wherein the framework comprises:
a FactoryCollection class, a Factory Base class from which application Factory classes may be defined, an AppClassBase class from which application classes may be defined, and an UpdateManager class for receiving and transmitting updates between the two entities.

18. The computer system of 17, wherein the FactoryCollection class comprises:
an UpdateFromPeer method for processing updates received from another entity, a BulkUpdate method for performing a bulk update, and a Register method for registering application Factory objects.

19. The computer system of 17, wherein the FactoryBase class comprises:
a Create method for creating an application object, a Delete method for deleting an application object, an UpdatePeer method for processing updates to be transmitted to another entity, an UpdateFromPeer method for processing updates received from another entity, and a BulkUpdate method for performing a bulk update.

20. The computer system of claim 17, wherein the AppClassBase class comprises:
an UpdatePeer method for processing updates to be transmitted to another entity, an UpdateFromPeer method for processing updates received from another entity, a BulkUpdate method for performing a bulk update, and a Register method for registering an application object.

21. The computer system of claim 17, wherein the UpdateManager class comprises:
an IsActive attribute for identifying whether the entity is an active entity or a standby entity.

22. The computer system of claim 17, wherein the framework further comprises:
an AppClassDescriptor class and an AppAttrDescriptor class for describing attributes of an application class.

23. The computer system of claim 17, wherein the framework further comprises:
an AppAttrBase class from which all attributes are derived.

24. The computer system of claim 17, wherein the framework further comprises:
an AttrTypeDescriptor class.

25. A method for transparent mirroring, comprising:
manipulating an application object, wherein manipulation of the application object automatically causes a message to be transmitted to the second entity requesting a corresponding manipulation of an application object to be performed at the second entity.

26. The method of claim 25, wherein the manipulation causes creation of an application object.

27. The method of claim 26, further comprising:
invoking a Create method of an application Factory object to cause creation of the application object.

28. The method of claim 26, wherein creation of the application object causes registration of the application object with an application Factory object.

29. The method of claim 26, wherein creation of the application object causes registration of attributes of the application object.

30. The method of claim 25, wherein the manipulation causes deletion of an application object.

31. The method of claim 30, further comprising:
invoking a Delete method of an application Factory object to cause deletion of the application object.

32. The method of claim 25, wherein the manipulation causes update of an attribute of the application object.

33. The method of claim 32, further comprising:
performing the update of the attribute with an assignment operator.

34. The method of claim 25, wherein the manipulation causes modification of a value of a hardware register.

35. The method of claim 25, further comprising:
creating an application Factory class corresponding to the application object; and registering the application Factory object with a FactoryCollection object.

36. The method of claim 25, further comprising:
invoking a BulkUpdate method of a FactoryCollection object to cause one or more messages to be transmitted to the second entity.

37. The method of claim 25, wherein the message comprises one or more entries indicating a creation, deletion, or update of an application object.

38. The method of claim 25, wherein the first entity comprises an active computer and the second entity comprises a standby computer connected via a network.

39. The method of claim 25, wherein the first entity comprises a first board and the second entity comprises a second board connected via a bus.

40. The method of claim 25, wherein an attribute of the application object is identified by a class identifier, an attribute identifier, and an object identifier.

41. A computer-readable storage medium storing a computer program executable by a computer, the computer program comprising instructions for:
manipulating an application object, wherein manipulation of the application object automatically causes a message to be transmitted to the second entity requesting a corresponding manipulation of an application object to be performed at the second entity.

42. The computer-readable storage medium of claim 41, wherein the manipulation causes creation of an application object.

43. The computer-readable storage medium of claim 42, wherein the computer program further comprises instructions for:
invoking a Create method of an application Factory object to cause creation of the application object.

44. The computer-readable storage medium of claim 42, wherein creation of the application object causes registration of the application object with an application Factory object.

45. The computer-readable storage medium of claim 42, wherein creation of the application object causes registration of attributes of the application object.

46. The computer-readable storage medium of claim 41, wherein the manipulation causes deletion of an application object.

47. The computer-readable storage medium of claim 46, wherein the computer program further comprises instructions for:
invoking a Delete method of an application Factory object to cause deletion of the application object.

48. The computer-readable storage medium of claim 41, wherein the manipulation causes update of an attribute of the application object.

49. The computer-readable storage medium of claim 48, wherein the computer program comprises instructions for:
performing the update of the attribute with an assignment operator.

50. The computer-readable storage medium of claim 41, wherein the manipulation causes modification of a value of a hardware register.

51. The computer-readable storage medium of claim 41, wherein the computer program further comprises instructions for:
creating an application Factory class corresponding to the application object; and
registering the application Factory object with a FactoryCollection object.

52. The computer-readable storage medium of claim 41, wherein the computer program further comprises instructions for:
invoking a BulkUpdate method of a FactoryCollection object to cause one or more messages to be transmitted to the second entity.

53. The computer-readable storage medium of claim 41, wherein the message comprises one or more entries indicating a creation, deletion, or update of an application object.

54. The computer-readable storage medium of claim 41, wherein the first entity comprises an active computer and the second entity comprises a standby computer connected via a network.

55. The computer-readable storage medium of claim 41, wherein the first entity comprises a first board and the second entity comprises a second board connected via a bus.

56. The computer-readable storage medium of claim 41, wherein an attribute of the application object is identified by a class identifier, an attribute identifier, and an object identifier.
